(19) United States
(12) Patent Application Publication
(10) Pub. No.: US 2020/0226530 A1
(43) Pub. Date: Jul. 16, 2020

(54) Artist Anywhere

(71) Applicants: Steve Hanifi, Centreville, VA (US); Shahriar-Moshtael Kashani, Centreville, VA (US)

(72) Inventors: Steve Hanifi, Centreville, VA (US); Shahriar-Moshtael Kashani, Centreville, VA (US)

(21) Appl. No.: 16/246,553

(22) Filed: Jan. 14, 2019

(51) Int. Cl. G06Q 10/06; G06F 16/9035; G06Q 10/10

(52) U.S. Cl. CPC G06Q 10/063112; G06Q 10/1093; G06F 16/9035

(57) ABSTRACT

The present invention discloses a talent search system specifically designed for performing art database management intended to promote an accurate and efficient supporting talent selection by semi-automatically and automatically registering characteristics of a plurality of sides about a talent. The system proposes a talent search system, a profile database in which information and features about the talent are stored is referred to, and talent information matching search conditions is searched and presented. The system allows the searcher to use multiple types of filters to reach to the final set of desirable information. Thus enabling the user to book who he/she desires for the event based on a calendar based system in where the artists set their own schedule and mark whether they are available or not on any day he/she may select.

### BACKGROUND

### Field of the Invention

The present invention relates to an automated system and method for managing and/or facilitating talent pool search and more particularly to a computer automated system implementing a comprehensive workforce-directed, artist database management, search, and position matching capability.

### Description of the Related Art

Selection of artist while initiating any production work is a detailed and cumbersome task. It is no less than a normal talent selection process. The team goes through a rigorous search for the right artist selection as per their need. Whether it's a question of selection of a performing artist, writer, singer, photographer, videographer, dance artist or any other performing art, the whole process is a long and tedious exercise. Moreover, the selection as per requirement like experience level, physical requirements and other are also done on reference based. For the performing artists to market themselves effectively, it has long been a custom in the industry that the performing artists compile information about themselves, referred to generally herein as “talent information,” often in the form of a “portfolio,” suitable for presentation to the industry talent consumers. The specific talent information that is compiled in a given instance depends upon the industry, the particular artist, his or her experience or credits, and potentially a host of other factors. Till to date there is no authentic database that has been developed which helps the selection team and ease them in the decision-making process. There are multiple inventions that have been developed in prior art that focus on developing database and perform useful analysis whether its employee selection for corporate environment or artist selection for any production job.

An Electronic employee selection systems and methods bearing U.S. Pat. No. 7,080,057B2 is issued to Kronos Talent Management Inc. The system describes an automated employee selection system can use a variety of techniques to provide information for assisting in selection of employees. For example, pre-hire and post-hire information can be collected electronically and used to build an artificial-intelligence based model. The model can then be used to predict a desired job performance criterion (e.g., tenure, number of accidents, sales level, or the like) for new applicants. A wide variety of features can be supported, such as electronic reporting. Pre-hire information identified as ineffective can be removed from a collected pre-hire information. For example, ineffective questions can be identified and removed from a job application. New items can be added and their effectiveness tested. As a result, a system can exhibit adaptive learning and maintain or increase effectiveness even under changing conditions.

A JP patent 2,001,282,977A discloses a method and system for employing talent and recording medium having processing procedure for employing talent recorded thereon is issued to Sony Co. The patent describes a problem i.e. to apply a talent employing method to a system for offering a job through the Internet and to smoothly operate the system. SOLUTION: A password and an identification code are issued at the Time of application. A judged result is informed in response to access using the password and the identification code. Disqualification is left in record and pass or fail is judged by comparison with the record.

A US patent 20020198766A1 is a Human capital management inventory and position matching system and methods is issued to US20020198766A1. The method discusses a computer based human capital management system provides for collecting information from any combination of position applicants, employees, and reserve pool talent reflective of the position skills, performance, and requirements thereof. The quality of the collected information can be normalized by supervisory review. The collected information is searchable by skill, performance, and other requirements with the search results being scored and ranked. The collected information may also be evaluated against a position specification establishing a weighting profile reflective of a position skills, performance, and requirements set presumed appropriate for a defined position. The position evaluation returns a scored and ranked list of candidates for the defined position, which can then be subjected to managerial review. Additional information can be requested as part of the managerial review, leading to a potential revision in the scored and ranked list of candidates.

A talent management system and methods for reviewing and qualifying a workforce utilizing categorized and free-form text data is a U.S. Pat. No. 7,437,309B2 is issued to Corporate Fables Inc. It is a computer based human capital management system provides for collecting information from any combination of position applicants, employees, and reserve pool talent reflective of the position skills, performance, and requirements thereof. The quality of the collected information can be normalized by supervisory review. The collected information is searchable by skill, performance, and other requirements with the search results being scored and ranked. The collected information may also be evaluated against a position specification establishing a weighting profile reflective of a position skills, performance, and requirements set presumed appropriate for a defined position. The position evaluation returns a scored and ranked list of candidates for the defined position, which can then be subjected to managerial review. Additional information can be requested as part of the managerial review, leading to a potential revision in the scored and ranked list of candidates. A computer based human capital management system provides for collecting information from any combination of position applicants, employees, and reserve pool talent reflective of the position skills, performance, and requirements thereof. The quality of the collected information can be normalized by supervisory review. The collected information is searchable by skill, performance, and other requirements with the search results being scored and ranked. The collected information may also be evaluated against a position specification establishing a weighting profile reflective of a position skills, performance, and requirements set presumed appropriate for a defined position. The position evaluation returns a scored and ranked list of candidates for the defined position, which can then be subjected to managerial review. Additional information can be requested as part of the managerial review, leading to a potential revision in the scored and ranked list of candidates.

A Virtual studio for identifying and developing public talent bearing US patent 20120047077A1 is issued to Public Record Inc. The teachings generally relate to a method of creating a derivative artistic work that includes a select, virtual submission from the public obtained from a set of random, virtual submissions submitted, for example, through a network or public venue. The teachings are directed a virtual studio, a method of creating a derivative, multi-track musical work that includes a virtual performance from the public.

It has to be noted that the current invention proposes an advancement in providing a Talent search system, program, and recording medium and to provide a talent search system for accurately and efficiently supporting talent selection automatically registering characteristics of a plurality of sides about a talent. The application can be utilized on professional requirements or personal requirements. Artist can be hired for birthday parties, bachelor parties, club events, private shows, public shows, concerts or any other social gatherings. The uniqueness of our Invention is that weddings were alleviating and taking out all the headache in planning next event and even artists can book other artists.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of improved talent selection as per user's requirement.

It is another objective of the invention to provide a system and method for facilitating artist selection involving a plurality of talent information users and talent information providers wherein access to selected ones of the talent files and the talent information is restricted and can be controlled on the basis of desired requirements.

It is further the objective of the invention to provide a multiple selection criterion to improve the quality of filtered data.

It is another objective of the invention to provide multiple categories of performing artist database to achieve the status of a one stop solution.

A further object is to provide an assembly that is simple and easy to use.

A still further object is to provide a system that reduces the time and cost involved in the process.

It is a further object of the present invention to provide a strong database which is of a durable and reliable algorithm thus providing a comprehensive and consistent data source.

Still yet another object of the present invention is to provide a new and improved artist selection system which provides in the apparatuses and methods of the prior art some of the advantages thereof, while simultaneously overcoming some of the disadvantages normally associated therewith.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, FIGURES, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

One aspect of the present application is directed to provide an application is exclusively for the entertainment industry which allows client to search for specific talent (models, actors, musicians, performers, etc) and then allows them to search for specific criteria within the talent they seek to narrow down the database. This app is designed with the concept of eliminating casting calls and the need for agencies throughout the world. This also allows hands-on search ability for the users and manage their needs on personal requirement basis, without assistance of any agencies.

As per preferred embodiment of the invention the system provides the user a simple interface which allows them to select the artist of their choice within few minutes. The system has talent interface which allows them to go deep into their desired categories. The talent category is further divided into Models, Actors, Musicians, photography, Writers, Performing arts and other. The user can select their desired category to go further deep down to filter out their requirements.

The Model category as per preferred embodiment of the invention is divided into Fashion, print, reality TV, runway, petite, fitness, glamour, bikini and promo. The user can further select their desired model on the basis of Age group, Experience, Location, Physical build, Eye color, Ethnicity, Hair type and length, Hair Style, Hips, Bust, Waist, Chest and Neck size.

As per further embodiment of the invention the system further allows the selection of performing actor as per selector's requirement. The artist can be selected as per roles in commercial, films, reality TV, theatre and music videos. Furthermore, the artist can be further scrutinized on the basis of their Genre, Experience, Gender, Age Group, Physical build, Eye color, Ethnicity, Hair type and length, Hair Style, Hips, Bust, Waist, Chest and Neck size. [0025] As per additional embodiment of the invention the musician category can be further expanded to the type of music which includes, Country, Blues, Jazz, Hip Hop, Easy Listening, Rock, Rap, Latino, Theatrical, others and All. Furthermore, the musicians can be divided on the basis of their Role including Singers, Record producers, Strings, Keyboards, Percussion, DJ, Wind, Brass and others. The musician can be filtered on the basis of their experience, gender, Physical build, Eye color, Ethnicity, Hair type and length, Hair Style, Hips, Bust, Waist, Chest and Neck size.

As per further embodiment of the invention the performing Art category will further expand into Drama, Dance, Comedy, Magician, Stunt man, Circus Art, Life coach, motivational speaker, psychic and other. The musician can be filtered on the basis of their experience, gender, Physical build, Eye color, Ethnicity, Hair type and length, Hair Style, Hips, Bust, Waist, Chest and Neck size.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

I: A talent search system where:
the system allows an interface for user to logged in;
where on successful log in an interface allow user to land on home screen; where the home screen allows the user to select the pre-defined search option;
where user can select the manual search option as well;
where the user can further filter out the requirements to select their desired individual.

II: A talent search system where the system relates to an automated system and method for managing and/or facilitating artist talent pool search including Models, Actors, Musicians, Photography, Performing arts and other and more particularly to a computer automated system implementing a comprehensive workforce-directed, artist database management, search, and position matching capability.
